(19) United States
(12) Patent Application Publication
(10) Pub. No.: US 2005/0183776 A1
(43) Pub. Date: Aug. 25, 2005

(54) Pressure regulator

(76) Inventors: Gerald Matranga, Franksville, WI (US); Andrew Clark, Vernon Hills, IL (US)

Correspondence Address: VONBRIESEN & ROPER, S.C., 411 EAST WISCONSIN AVENUE, SUITE 700, MILWAUKEE, WI, 53202, US

(21) Appl. No.: 10/784,854

(22) Filed: Feb. 23, 2004

(51) Int. Cl. G05D 16/04

(52) U.S. Cl. 137/509

(57) ABSTRACT

The present invention is a pressure regulator for regulating a fluctuatable fluid pressure of a fluid flow, the fluid flow being received from a first device and being transmitted to a second device, including a spool valve being translatable between a closed non-regulating disposition and an open regulating disposition, a throttled portion of a fluid flow acting on a first spool working surface and a main portion of the fluid flow acting on a second opposed spool working surface. A method of regulating a fluctuatable fluid pressure is further included.

### FIELD OF THE INVENTIION

The present invention relates to pressure regulators. More particularly, the present invention relates to pressure regulators useful for regulating fluid pressure from a pulsating source, such as a gear pump.

### BACKGROUND OF THE INVENTION

In an exemplary apparatus having a motive force, such as an internal combustion engine, and an output shaft for application of force or power to a device, an engagable transmission may be interposed between the motive force and the output shaft. The transmission may have a single clutch or multiple clutches for disengaging the transmission from the motive force. The transmission clutch(es) is typically actuated through the use of oil under pressure to translate a piston and compress the clutch plates. Oil pressure is typically developed by use of a gear pump. Such a pump has at least one pair of counter-rotating meshing gears. Oil is pumped by each pair of meshing gear teeth of the respective gears. High pressure oil is discharged from the meshed gear teeth by rotation of the gears. Each gear pair carries a volume of fluid and displaces the volume at high pressure out an exit port. A pressure regulator typically receives the pump flow, allows the pressure to increase to the setting of the pressure regulator, and discharges oil at the pressure setting of the pressure regulator.

A characteristic of a gear pump is a pulsating outlet flow characterized by pressure pulsations. Pulsation is caused by the displacement of fluid by each meshed gear pair of the respective gears of the pump. For example, a pump with ten teeth on each of the gears that is operated at 600 rpm will produce a pulsation at the rate of 100 times per second or 100 hertz. The average regulated pressure of a certain pressure regulator may be 350 psi, but the pressure pulsation generator by the gear pump may be ±50 psi. The regulator pressure then has a range of 300 to 400 psi. The deleterious effects of the pulsations are as follows:

1) The torque capacity of a clutch in the example above is based on 350 psi. The lower pressure of 300 psi may compromise clutch capacity.

2) Components downstream of the pressure regulator are exposed to the highest pressure (400 psi) developed by the pulsations of the gear pump. The rating of these components has to allow for the higher pressure. Accordingly, such components must be unduly strengthened in order to bear the abnormally high pressure.

3) Electric valves may be used to direct oil to each clutch in the transmission for engagement. The frequency of the pulsations generated by the gear pump may excite a natural frequency of the electric valves, causing larger pressure pulsations and/or accelerated wear of the electric valve.

4) The pressure pulsations generated by the gear pump may excite the natural frequency of the valve and the pressure regulator, causing a potentially harmful increased magnitude in oil pressure transmitted to the clutches.

A classic relief valve is depicted in prior art FIG. 1. Classic relief valves are designed such that pressure from the gear pump acts directly on the end area of the spool that is shiftably disposed within the relief valve. When sufficient pressure (force) is generated on the spool end area to overcome the force of the spring holding the spool closed, the spool translates upward permitting oil to flow through the outlet to the clutch. Fluid flow in the classic relief valve is coaxial with and in the same direction as the opening movement of the spool.

There is a need in the industry for a pressure regulator that minimizes or eliminates the pulsations in pressure generated by a gear pump.

### SUMMARY OF THE INVENTION

The pressure regulator of the present invention substantially meets the aforementioned needs of the industry. The pressure regulator of the present invention includes a shiftable spool having a truncated conical shape. Further, as compared to the aforementioned classical relief valve, flow through the pressure regulator of the present invention is opposite to that of the classical relief valve. Such reversal of flow does not permit the full flow of oil under pressure from the gear pump to bear on the end area of the spool. Further, the oil under pressure from the gear pump that does bear on the end area of the spool is throttled.

The design of the pressure regulator of the present invention provides for much greater valve stability, which results in a constant fluid pressure at a selected pressure. Such stability is evidenced over a wide range of fluid flows. For example, the pressure regulator will maintain a stable 350 psi output when an engine is at idle at 600 rpm with a relatively low flow rate and when the engine is at 2100 rpm with a much greater flow rate. In the past, as flow rate increased, the output pressure of prior art pressure regulators would tend to creep up. Advantageously, the output pressure characteristic of the pressure regulator of the present invention is very flat. The valve stability of pressure regulator of the present invention is enhanced by the following.

1) The fluid flow direction through the valve is in a reverse direction as compared to classic prior art relief valves.

2) Movement of the spool is controlled by pressure acting on the end area of the spool. Spool movement is dampened by restricting (throttling) the free flow of pressurized fluid from the gear pump acting on the end of the spool.

3) The conical shape of the spool adds to the stability of the regulator. The spool shaped flow chamber reduces the axial force caused by the fluid momentum. The reduction in axial force reduces the effect of flow forces acting to close the spool barrel.

The present invention is a pressure regulator for regulating a fluctuatable fluid pressure of a fluid flow, the fluid flow being received from a first device and being transmitted to a second device, including a spool valve being translatable between a closed non-regulating disposition and an open regulating disposition, a throttled portion of a fluid flow acting on a first spool working surface and a main portion of the fluid flow acting on a second opposed spool working surface. A method of regulating a fluctuatable fluid pressure is further included.

### BRIEF DESCRIPTION OF THE DRAWINGS

FIG. 1 is a sectional view of a prior art relief valve;

FIG. 2 is a bottom view of the pressure regulator of the present invention;

FIG. 3 is a top view of the pressure regulator;

FIG. 4 is a side view of the pressure regulator with a portion depicting the mounting bolt broken away;

FIG. 5 is an end view of the pressure regulator;

FIG. 6 is a sectional view of the pressure regulator taking along a section line 6-6 of FIG. 5.

FIG. 7 is a sectional view of the pressure regulator taking along the central line of the pressure regulator;

FIG. 8 is a side view of an optional temperature sensor for use with the pressure regulator;

FIG. 9 is a perspective view of the pressure regulator with the internal components depicted in the non-regulating disposition;

FIG. 10 is a perspective view of the pressure regulator with the internal components depicted in the regulating disposition;

FIG. 11 is a perspective view of the pressure regulator depicting the internal components thereof including the check valve and orifice; and

FIG. 12 is a perspective sectional view of the pressure regulator.

### DETAILED DESCRIPTION OF THE DRAWINGS

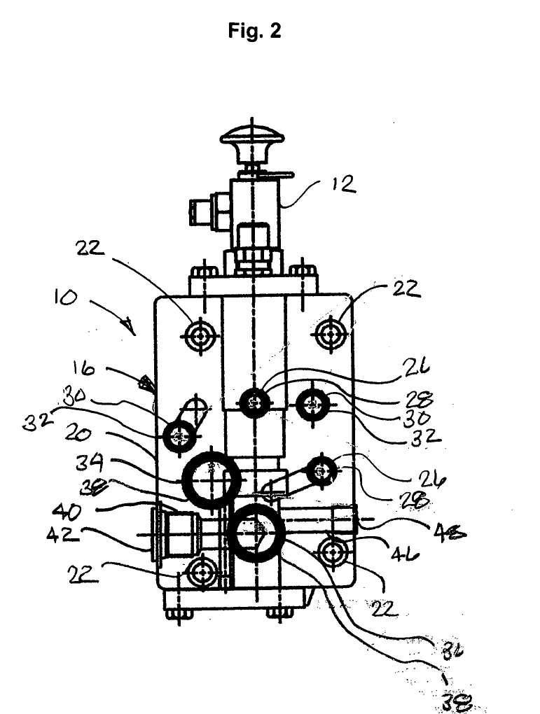

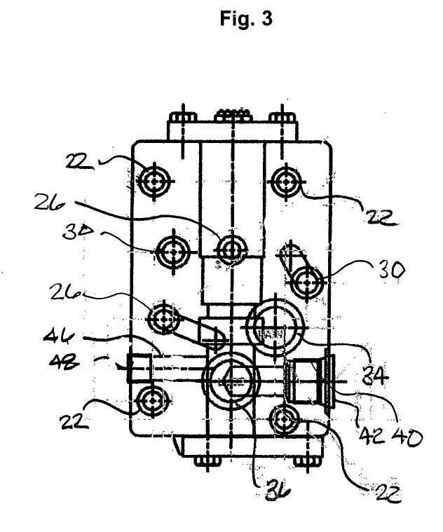

The pressure regulator of the present invention is shown generally at 10 in the figures. The pressure regulator 10 is depicted in FIGS. 2, 4, 5, and 7 with a manual override 12 mounted thereon. It should be noted that in the discussion below, the various ports that are described carry transversely through the pressure regulator 10. On the bottom side of the pressure regulator 10 (see FIG. 2) such ports mate with corresponding ports on the transmission (or other device) to which the pressure regulator 10 is mounted. On the upper side of the pressure regulator 10 (see FIG. 3) such ports mate with corresponding ports in the manual override 12. The manual override 12 is in fluid communication with the transmission or other device being serviced by the pressure regulator 10.

The pressure regulator 10 has two major sub-components: housing assembly 16 and valve assembly 18.

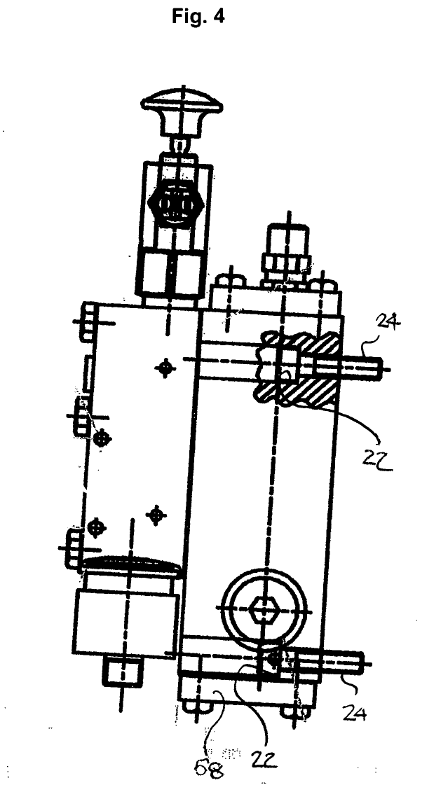

Turning first to the housing assembly 16, the housing assembly 16 has a housing body 20 as depicted in FIGS. 2-5. The housing body 20 is preferably formed of a unitary metallic block of material. The various ports and bores as will be described below are then formed in the housing body 20 by suitable boring operations. Provision is made for mounting the pressure regulator 10 to a transmission by means of sunken mount bores 22 (see FIG. 4) and cap screws 24 disposed therein. The cap screws 24 may be threaded into corresponding threaded bores defined in the transmission.

The first of the ports from the pressure regulator 10 are the transmission sump ports 26 noted in FIGS. 2 and 3. O-rings 28 are disposed in the transmission sump ports 26 that are in fluid communication with the transmission to which the pressure regulator 10 is mated.

The second set of ports is the transmission clutch ports 30. Again, O-rings 32 are fitted in the transmission clutch ports 30 to ensure a fluid tight seal when the pressure regulator 10 is mated to the transmission.

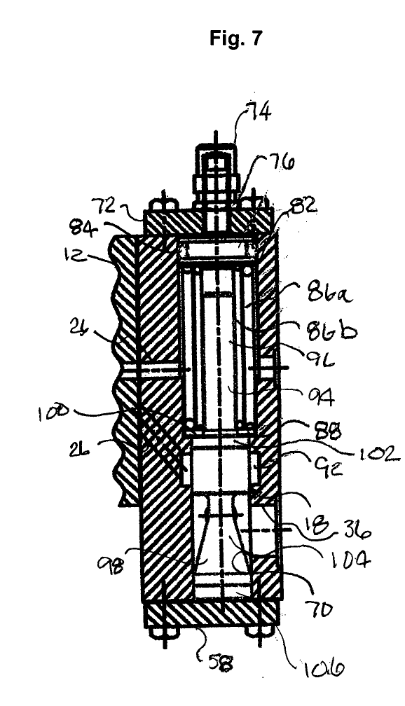

A main transmission port 34 is defined in the housing body 20 of the pressure regulator 10. Additionally, a lubrication port 36 is defined in the housing body 20. The lubrication port 36 is also depicted in FIG. 7. The main transmission port 34 and the lubrication port 36 are fitted with O-rings 38 for sealingly mating with the transmission. An optional lubrication port 40 is defined on the side of the housing body 20. The optional lubrication port 40 is in fluid communication with the lubrication port 36. When not used, the optional lubrication port 40 is sealed with a plug 42.

An optional sensor port 46 is defined in the opposing side of the housing body 20 from the optional lubrication port 40. The optional sensor port 46 is sealed with a plug 48 when not used.

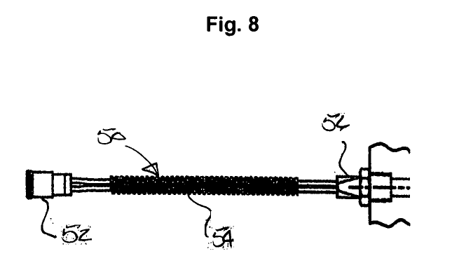

Referring to FIG. 8, a temperature sensor 50 is depicted. The temperature sensor 50 includes at a first end socket contacts 52. A cable 54 is attached to the socket contacts 52. A sensor 56 is disposed at the opposite end of the cable 54. The sensor 56 may be disposed in the optional sensor port 46 when the temperature sensor 50 is utilized with the pressure regulator 10.

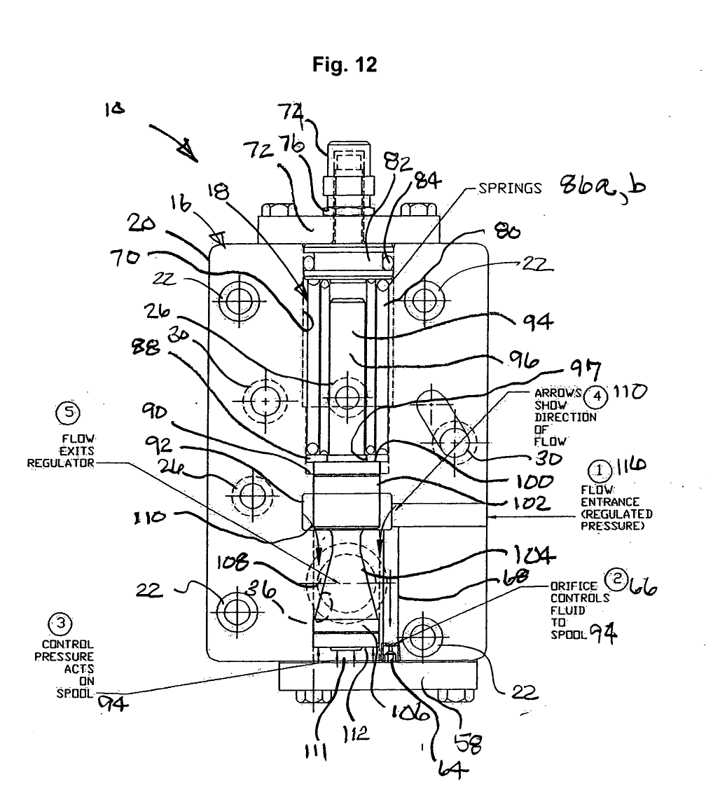

Turning now to the second of the major sub-components of the pressure regulator 10, the valve assembly 18. A pair of generally parallel fluid passages 62, 68 comprise the first components of the valve assembly 18. The fluid passages 62, 68 are preferably offset from and parallel to the longitudinal axis of the pressure regulator 10. Flow in the passages 62, 68 is a indicated by arrows in FIG. 12, as will be noted in greater detail below.

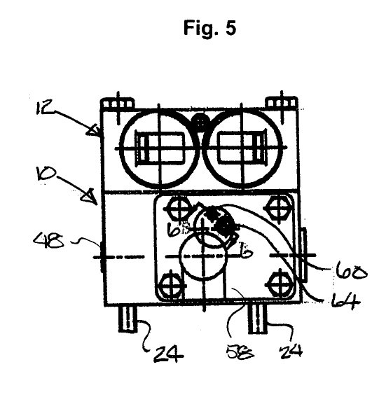

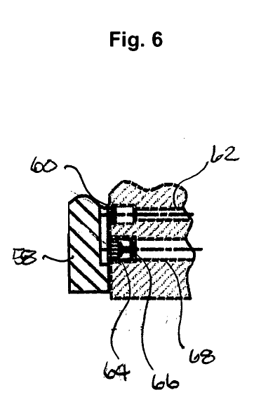

A cover 58 is disposed on an end of the pressure regulator 10, as depicted in FIG. 5, covering a discharge end of the passages 62, 68. As depicted in FIG. 6, a check valve 60 is disposed in an end of the first of the two passages, the refill passage 62. Flow passages 62, 68 are fluidly coupled to main transmission port A 34.

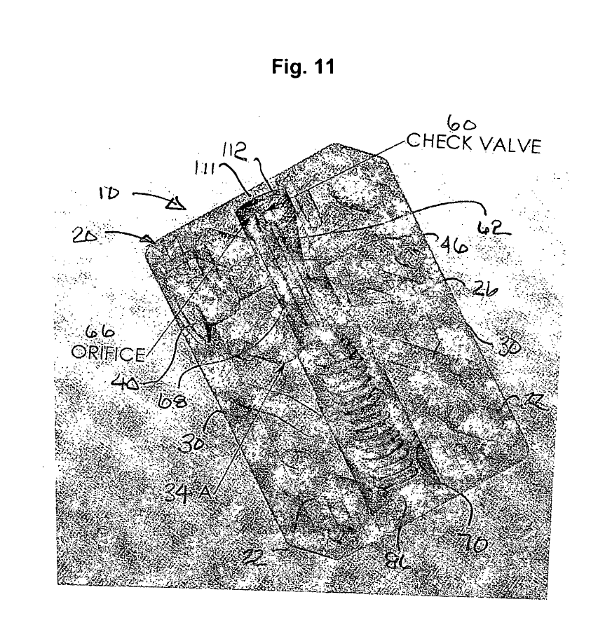

A filter 64 is disposed in the end of the second of the two passages, the spool inlet passage 68. Adjacent to the filter 64 is an orifice 66. The orifice 66 throttles the amount of fluid (oil) that is available to the valve assembly 18 to perform the translating function thereof. The orifice 66 is preferably between 0.010 inches in diameter and 0.060 inches in diameter. The orifice 66 is most preferably 0.30 inches in diameter. As depicted in FIG. 11, the refill passage 62 and the spool inlet passage 68 are in fluid communication with the valve bore 70 and main transmission port A 34.

The valve bore 70 is preferably defined parallel to the longitudal axis of the housing body 20, as depicted in FIGS. 7 and 12. The valve bore 70 is sealed at a first end by cover 58 and at a second opposed end by cover 72. Cover 72 has a cap 74 disposed thereon and a nut 76 for securing the cap 74 to the cover 72.

A spring assembly 80 resides within the upper portion of the valve bore 70. Spring assembly 80 includes a fixed stop washer 82 disposed immediately beneath the cover 72. A sealing ring 84 fluidly seals the valve bore 70.

A pair of concentric coil springs 86a, b are disposed beneath the fixed stop washer 82. It should be noted that a single coil spring 86, as depicted I FIG. 12, may be utilized in place of the concentric coil springs 86a, b.

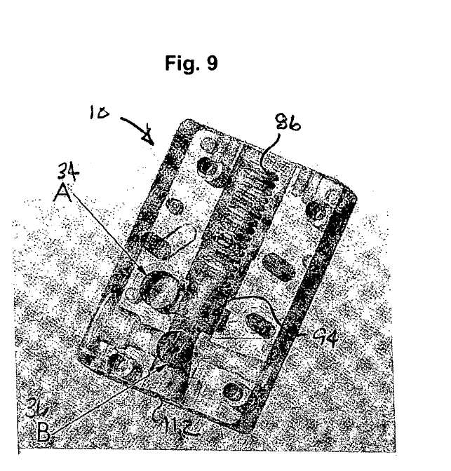

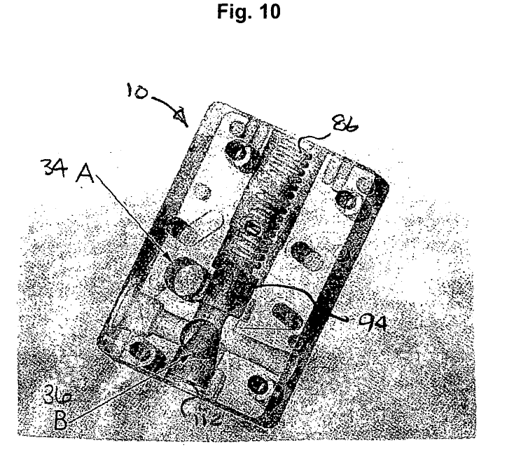

The concentric springs 86a, b are retained within the valve bore 70 at a first spring end by the fixed stop washer 82 and at a second spring end by a shiftable stop washer 88. In the non-regulating disposition, a portion of the underside of the shiftable stop washer 88 bears on the step 90 defined in the valve bore 70. See FIGS. 7 and 9. In the regulating disposition, the shiftable stop washer 88 is shifted upwards off of the step 90, compressing the springs 86a, b, as depicted in FIGS. 10 and 12.

An annular groove 92 is formed in the valve bore 70 immediately beneath the structure forming the step 90. The annular groove 92 is in flow communication with the flow entrance port 116.

A spool valve 94 resides within the valve bore 70 in a concentric disposition. The valve 94, as depicted in FIGS. 7 and 12, has an upper cylindrical portion 96. The cylindrical portion 96 is disposed interior to the two concentric springs 86a, b. The cylindrical portion 96 passes through the bore 97 defined in the shiftable stop washer 88.

Immediately below the cylindrical portion 96 is the spool valve portion 98. The spool valve portion 98 has a shoulder 100 that is defined by a land 102. The diameter of the land 102 is greater than the diameter of the cylindrical portion 96, thereby defining the shoulder 100. The shoulder 100 bears on the underside of the shiftable stop washer 88 and carries the shiftable stop washer 88 upward during translatory motion of the valve 94 from the non-regulating disposition to the regulating disposition.

The conical section 104 of the valve 94 is disposed immediately below the land 102, defining a conical flow passage 108. The conical flow passage 108 could as well be defined by an annular conical groove defined in the valve bore 70. The conical section 104 is a truncated cone (frusto conical) shape and tapers from a narrow diameter proximate the land 102 to a diameter that is substantially equal to the inside diameter of the valve bore 70 proximate the lower land 106. The conical section 104 defines the conical annular flow passage 108 between the exterior margin of the conical section 104 and the inside diameter of the valve bore 70. The flow area of the conical annular flow passage 108 is greatest at its upper portion where flow enters the passage 108 and decreases in flow area with the decreases in diameter of the conical section 104 at the discharge end of the passage 108 The conical annular flow passage 108 is in flow communication with the lubrication port 36. The main flow of fluid from the pump to the device serviced by pressure regulator 10 is through passage 108.

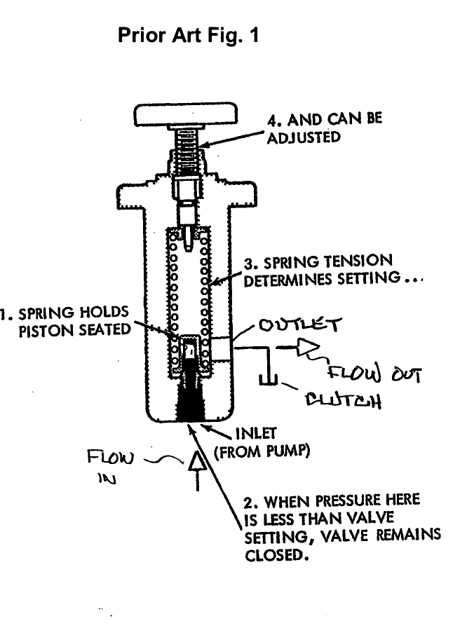

Referring to FIG. 12, fluid flow though the pressure regulator 10 is in the opposite direction as compared to the relief valve of Prior Art FIG. 1. As indicated by arrows 110, oil flow is opposite the spool valve 94 opening direction, which is upward in the depiction in FIG. 12. A variable volume chamber 111 is defined in part by cover 58, valve bore 70 and end 112 of spool valve 94. Fluid pressure in chamber 111 generates a translatory force acting on end 112. Spool valve 94 movement is controlled by a control pressure at the end 112 of the spool valve 94. This arrangement has a significant desirable effect on the stability on the valve 94 and of the pressure regulator 10.

Movement of the valve 94 is controlled by oil pressure acting on the end 112 of the valve 94. Oil acting on end 112 is delivered through the spool inlet passage 68 and is restricted by the orifice 66 at the end of the spool inlet passage 68. The orifice 66 restricts the free flow of oil to the end 112, thereby at least in part effecting the desired pressure fluctuation dampening.

The dampened spool valve 94 responds to the force generated by fluid pressure in the chamber 111. Chamber 111 may be devoid of fluid under certain circumstances. Flow through the spool inlet passage 68 is bypassed under such circumstances. This condition may occur when the clutch is engaged or under cold oil starts. Under such conditions, oil is tapped off the main flow from port 34, and flows through the refill passage 62 and the check valve 60, thereby bypassing the spool inlet passage 68. The check valve 60 opens and allows fluid to bypass the orifice 66 to rapidly fill the chamber 111. Check valve 60 closes when the chamber 111 is filled. Throttled fluid pressure, also tapped off the main flow from port A 34, passes through the orifice 66 then generates a force on the end 112 to overcome the bias of the springs 86a, b and to shift the valve 94 from the non-regulated disposition to the regulated disposition.

The conical section 104 of the valve 94 also contributes to the stability of the pressure regulator 10. The conical shape acts to reduce the axial force caused by the fluid momentum of the oil. This reduction in axial force reduces the effect of flow forces acting to shift the valve 94 from the regulating to the non-regulating disposition.

Referring to the non-regulating disposition of the pressure regulator 10 as depicted in FIG. 9, the valve 94 is depicted in the closed (non-regulating) disposition. No flow will pass through the pressure regulator 10 from the pump to the device being serviced by the pressure regulator 10 when the pressure regulator 10 is in this configuration.

Referring to FIG. 2, it is noted that the valve 94 has translated to the regulating disposition where oil at port A 35 is regulated to 350 psi by bypassing excess flow to port B 36. The valve 94 translates as a result of oil pressure generating a force at the end 112 of the valve 94 and overcoming the opposing bias exerted by the springs 86a, b.

The function of the check valve 60 and the orifice 66 is better understood with reference to FIG. 11. The function of the orifice 66 is to supply oil to the end 112 of the valve 94 and to translate the valve 94 to the regulating disposition against the bias of the springs 86a, b. The valve 94 cannot move without displacing fluid through the orifice 66. For cold start conditions, the chamber 111 at the end 112 of the valve 94 may be partially or fully evacuated. The valve 94 will not regulate until oil fills the empty chamber 111 and the pressure acting on the end 112 translates the valve to the regulated disposition noted in FIGS. 10 and 12. The time required to fill such chamber 111 will allow main pressure to spike upwards in excess of the regulated pressure (an exemplary 350 psi). The check valve 60 allows the oil to bypass the orifice 66 to quickly fill the chamber 111 that is defined in part by the end 112. When the chamber 111 is filled with oil, the check valve 60 closes and the oil resumes flow though the orifice 66. The flow through the orifice 66 provides the desired hydraulic dampening of the pressure regulator 10.

While a number of presently preferred embodiments of the invention have been illustrated and described, it should be appreciated that the invent of principals can be applied to other embodiments falling within the scope of the following claims.

1. A pressure regulator for regulating a fluctuatable fluid pressure of a fluid, the fluid being received from a first device and being transmitted to a second device, comprising:
A spool valve being biased in a closed non-regulating disposition, the fluid pressure being throttled through an orifice to act on a spool valve working surface, the throttled fluid pressure acting on the working surface acting in opposition to the bias to shift the spool valve from the closed non-regulating disposition to an open regulating disposition, the orifice acting to minimize fluid pressure fluctuations and to thereby stabilize the fluid pressure of the fluid transmitted to the second device.

2. The pressure regulator of claim 1, a fluid flow to the orifice being tapped off of a main flow of fluid, the main flow of fluid for transmission to the second device.

3. The pressure regulator of claim 2, the main flow of fluid flowing through the spool valve in a direction opposite to the direction of opening translation of the spool valve.

4. The pressure regulator of claim 2, the main flow of fluid flowing through a conical flow passage.

5. The pressure regulator of claim 2, the main flow of fluid flowing through a conical flow passage from a greater flow passage area to a lesser flow passage area.

6. The pressure regulator of claim 4, the conical flow passage being defined in part by the spool valve.

7. The pressure regulator of claim 4, the conical flow passage being defined in part by a conical groove defined in the spool valve.

8. The pressure regulator of claim 4, the conical flow passage having a main flow inlet disposed proximate a greater flow passage area and a main flow outlet disposed proximate a lesser flow passage area.

9. The pressure regulator of claim 1, an actuating fluid passage connecting a main flow inlet to the spool valve working surface, the orifice being defined in the actuating fluid passage.

10. The pressure regulator of claim 1, the orifice being between 0.010 inches in diameter and 0.060 inches in diameter.

11. The pressure regulator of claim 1, the orifice being substantially 0.030 inches in diameter.

12. The pressure regulator of claim 1, a bypass fluid passage bypassing fluid to the spool valve working surface when there is no fluid present to the working surface.

13. The pressure regulator of claim 12, the bypass fluid passage having a check valve disposed therein for closing the bypass passage when there is fluid present to the working surface.

14. A pressure regulator for regulating a fluctuatable fluid pressure of a fluid flow, the fluid flow being received from a first device and being transmitted to a second device, comprising:
A spool valve being translatable between a closed non-regulating disposition and an open regulating disposition, a throttled portion of a fluid flow acting on a first spool working surface and a main portion of the fluid flow acting on a second opposed spool working surface.

15. The pressure regulator of claim 14, the throttled portion of the fluid flow being tapped off of a main portion of fluid flow, the main portion of fluid flow for transmission to the second device.

16. The pressure regulator of claim 14, the main portion of fluid flowing through the spool valve in a direction opposite to a direction of opening translation of the spool valve.

17. The pressure regulator of claim 14, the main portion of fluid flow flowing through a conical flow passage.

18. The pressure regulator of claim 14, the main portion of fluid flow flowing through a conical flow passage from a greater flow passage area to a lesser flow passage area.

19. The pressure regulator of claim 14, the second spool working surface having a conical shape.

20. The pressure regulator of claim 14, the second spool working surface being a conical groove defined in the spool valve.

21. The pressure regulator of claim 14, a conical flow passage having a main flow inlet disposed proximate a greater flow passage area and a main flow outlet disposed proximate a lesser flow passage area.

22. The pressure regulator of claim 14, an actuating fluid passage connecting a main flow inlet to the first spool valve working surface, an orifice being defined in the actuating fluid passage.

23. The pressure regulator of claim 22, the orifice being between 0.010 inches in diameter and 0.060 inches in diameter.

24. The pressure regulator of claim 22, the orifice being substantially 0.030 inches in diameter.

25. The pressure regulator of claim 14, a bypass fluid passage bypassing fluid to the first spool valve working surface when there is no fluid present to the working surface.

26. The pressure regulator of claim 25, the bypass fluid passage having a check valve disposed therein for closing the bypass passage when there is fluid present to the working surface.

27. A method of regulating a fluctuatable fluid pressure of a fluid flow, the fluid flow being received from a first device and being transmitted to a second device, comprising:
Translating a spool valve between a closed non-regulating disposition and an open regulating disposition, acting on a first spool working surface with a throttled portion of a fluid flow and acting on a second opposed spool working surface with a main portion of the fluid flow.

28. The method of claim 27, including tapping the throttled portion of the fluid flow off of a main portion of fluid flow and transmitting the main portion of fluid flow to the second device.

29. The method of claim 27, including flowing the main portion of fluid through the spool valve in a direction opposite to a direction of opening translation of the spool valve.

30. The method of claim 27, including flowing the main portion of fluid flow through a conical flow passage.

31. The method of claim 27, including flowing the main portion of fluid flow through a conical flow passage from a greater flow passage area to a lesser flow passage area.

32. The method of claim 27, including forming the second spool working surface with a conical shape.

33. The method of claim 27, including forming a conical groove in the spool valve to define the second spool working surface.

34. The method of claim 27, including forming a main flow inlet disposed proximate a greater flow passage area of a conical flow passage and forming a main flow outlet disposed proximate a lesser flow passage area of the conical flow passage.

35. The method of claim 27, including connecting a main flow inlet to the first spool valve working surface with an actuating fluid passage and defining an orifice in the actuating fluid passage.

36. The method of claim 35, including defining the orifice being between 0.010 inches in diameter and 0.060 inches in diameter.

37. The method of claim 35, including defining the orifice substantially 0.030 inches in diameter.

38. The method of claim 27, including bypassing fluid to the first spool valve working surface by a bypass fluid passage when there is no fluid present to the working surface.

39. The method of claim 28, including checking the bypass fluid passage for closing the bypass passage when there is fluid present to the working surface.
